(19) United States
(12) Patent Application Publication
(10) Pub. No.: US 2004/0182170 A1
(43) Pub. Date: Sep. 23, 2004

(54) Test lead connector with strain relief

(76) Inventor: Rey P. Harju, Fullerton, CA (US)

Correspondence Address: John H. Lynn, Suite F 200, 2915 Redhill Avenue, Costa Mesa, CA, 92626, US

(21) Appl. No.: 10/390,811

(22) Filed: Mar. 17, 2003

(51) Int. Cl. G01N 3/02

(52) U.S. Cl. 73/856

(57) ABSTRACT

Providing strain relief for a test lead comprises passing the test lead through a housing that includes a generally elongate tubular member having a longitudinal cavity therein for retaining the test lead and maintaining a connection between the test lead and an electrical probe. A plurality of slots is formed in sidewall portions of the tubular member near an end thereof to provide flexibility, thereby providing strain relief for the test lead.

### BACKGROUND OF THE INVENTION

This invention relates generally to electrical leads for connecting a test probe to an electrical instrument and particularly to strain relief devices for preventing flexible test leads from breaking near their connections to a rigid probe or connector.

Prior art strain relief devices for test leads are either ineffective or expensive to manufacture.

### SUMMARY OF THE INVENTION

This invention overcomes difficulties associated with prior art strain relief devices for test leads. A method according to the invention for providing strain relief for a test lead, comprises the steps of passing the test lead through a housing that includes a generally elongate tubular member having a longitudinal cavity therein for retaining the test lead and maintaining a connection between the test lead and an electrical probe, and forming a plurality of slots in sidewall portions of the tubular member near an end thereof to provide flexibility, thereby providing strain relief for the test lead.

The method according to the invention preferably includes the step of arranging the slots in linearly separated pairs. Adjacent pairs of the slots preferably are arranged to be angularly displaced from one another in the tubular member. In a preferred embodiment of the invention adjacent pairs of the slots are displaced 900 from one another.

The tubular member preferably is arranged to have a flared end where the slots are formed.

The structure and function of the invention may be best understood by referring to the accompanying drawings, which are not to scale, and to the following detailed description.

### BRIEF DESCRIPTION OF THE DRAWINGS

FIG. 1 is a side elevation view of a pair of strain relief devices according to the invention used to interface a test lead with a test probe and with an electrical connector;

FIG. 2 is an end elevation view of an electrical connector that may be used with the strain relief device of FIG. 1;

FIG. 3 is a cross sectional view of the invention as shown in FIG. 1;

FIG. 4 is a top plan view of a strain relief device according to the invention enlarged to show structural features thereof;

FIG. 5 is an enlarged side elevation view of one of the strain relief devices of FIG. 1;

FIG. 6 is a cross sectional view of the strain relief device of FIG. 5;

FIG. 7 is a cross sectional view of the strain relief device as shown in FIG. 4;

FIG. 8 shows the strain relief device of FIG. 4 with the test lead bent about 90°; and

FIG. 9 shows the strain relief device of FIG. 6 with the test lead bent about 90°.

### DETAILED DESCRIPTION OF THE INVENTION

The following description is intended to describe an exemplary preferred embodiment of the invention. Specific structural details are described to explain how to make and use the invention. It should be recognized that modifications could be made to the specifically described structure without departing from the spirit and scope of the invention.

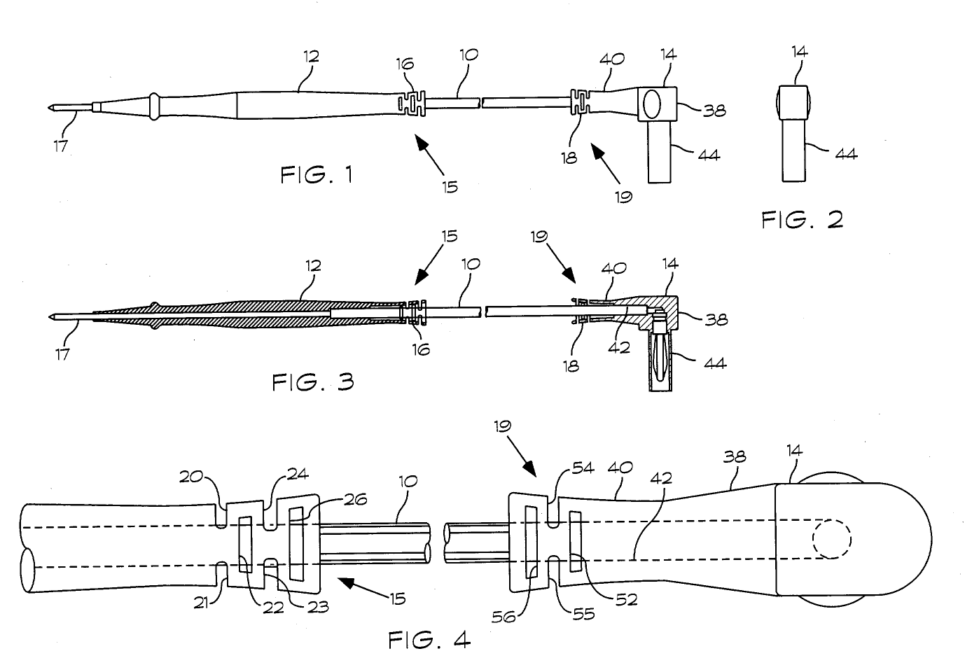

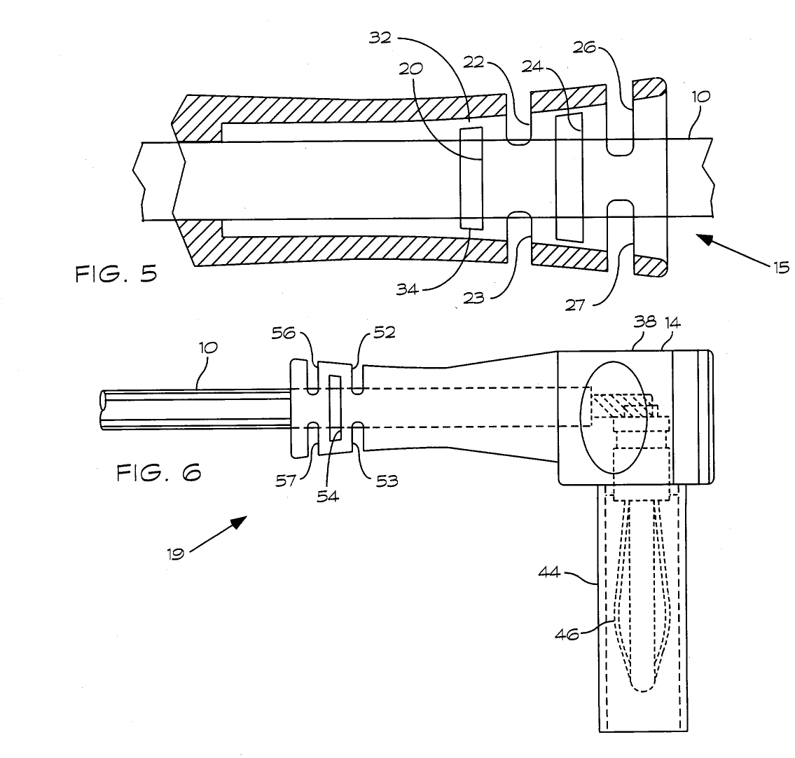

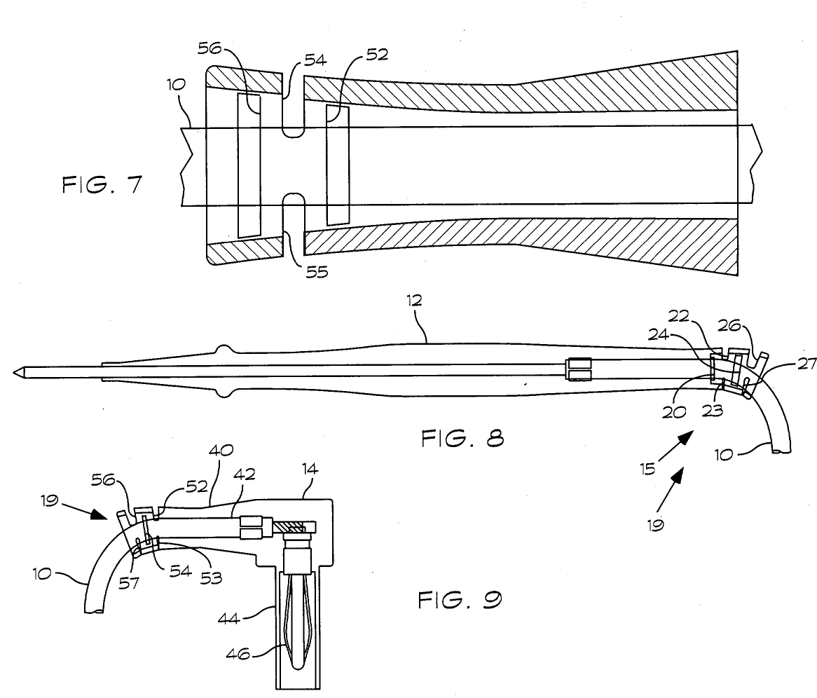

Referring to FIGS. 1-3 a test lead 10 extends between a test probe 12 and an electrical connector 14. The test lead 10 is connected to a flared end portion 16 of the test probe 12. The test probe 12 is formed as an elongate molded plastic tube having a central longitudinal cavity 13 therein. The test lead 10 extends through the central cavity 13 and is connected to a metal probe 17. The test lead 10 is also connected to a flared end portion 18 of the electrical connector 14.

Referring to FIGS. 1 and 3-5, the flared end portion 16 has a plurality of arcuate slots 20-27 formed therein to define a strain relief device 15. The material between adjacent slots forms a ladder-like arrangement that has flexibility sufficient to deform as the test lead is displace laterally away from the outer end of the strain relief device 15. The slots 20-27 extend through the sidewall 30 of the flared end portion 16 and are generally perpendicular to the longitudinal cavity 17. The slots 20-27 are arranged on the flared end 16 in linearly spaced apart pairs whose members are diametrically opposed. The slots 20-27 each form arcs that preferably range about 90° to 150°. The slots 20 and 21 are diametrically opposed so that they are separated by small portions 32 and 34 of the plastic material that forms the flared end portion 16. The slots 22 and 23 are separated lengthwise along the flared end 16 from the slots 20 and 21. The slots 22 and 23 are diametrically opposed and have their centers rotated 90° from the centers of the slots 20 and 21. The slots 24 and 25 are linearly spaced apart from the slots 22 and 23. The centers of the slots 24 and 25 are angularly displaced from the centers of the slots 22 and 23. The centers of the slots 24 and 25 are preferably aligned with the centers of the slots 21 and 22. The slots 26 and 27 are linearly spaced apart from the slots 24 and 25 and are preferably angularly aligned with the slots 22 and 23. The slots 21-27 preferably have widths that increase with proximity to the end 36 of the flared portion 16.

The electrical connector 14 includes a housing 38 that preferably is formed of molded plastic. The housing 14 includes a first tubular projection 40 that includes a central longitudinal cavity 42. A second tubular projection 44 extends from the housing 38 in a direction perpendicular to the projection 40. The test lead 10 extends through the cavity 42 and is connected to a terminal 46 that extends through the projection 44 for connection to an electrical test instrument (not shown).

The projection 40 includes a flared end 50 that has a plurality of slots 52-57 formed therein to define a strain relief device 19. The material between the slots 52-57 forms a ladder-like structure. The slots 52-57 are also arranged in linearly spaced apart pairs with the members of each pair being diametrically opposed in an arrangement that is similar to that of the slots 20-27.

The slots 56 and 57 preferably are wider than the slots 54 and 55, which are in turn preferably wider than the slots 52 and 53. The slots 21-27 preferably have widths that increase with proximity to the end 36 of the flared portion 16. Forming the slots 20-27 and 52-57 in the flared end portions 16 and 18, respectively, makes the flared end portions more flexible than the adjacent portions of the tube and the projection 40, respectively. Having the slot widths increase toward the end 36 of the flared portions 16 makes the flared end portion have progressively increasing flexibility toward the end 36. The increasing slot widths toward the end 60 of the flared end 18 provides similar progressively increasing flexibility toward the end 60

Referring to FIG. 8, bending the test lead 10 through a 90° angle as it emerges from the strain relief device 15 deforms the strain relief device 15 so that the slots 23 and 23 (for the example shown) close and prevent additional bending of the test lead 10. The sizes of the gaps and the widths of the ladder rungs are designed so that both slots end up closing at about the same time, thus providing the precise maximum radius on the bent wire.

Bending the test lead 10 90° in the opposite direction would compress the sides of the slots 22 and 26 together to prevent further bending. Bending the test lead 10 out of the plane of the paper would similarly deform the slots 20 and 24. Bending the test lead 90° into the plane of the paper of FIG. 8 would deform the slots 22 and 26 (shown in FIG. 4, not shown in FIG. 8).

Referring to FIG. 9, bending the test lead 10 as it emerges from the strain relief device 19 deforms the sides of the slots 53 and 57, which prevents further bending of the test lead 10. The strain relief device 19 functions essentially the same as the strain relief device 15.

The strain relief devices 15 and 19 provide the largest bend radius possible (given the length of the strain relief) for a wire pulled at a 90° angle. The strain relief devices 15 and 19 accomplish this by making the size of the slots 20-27 and 52-57 and the size of the“ladder rungs” between them so that the slots enclosed in the arc through which the test lead 10 is bent close almost simultaneously as the wire is pulled at 90 degrees. The sides of the latter are just thin enough to bend well (the whole strain relief section flops in the direction of the lead pull), yet big enough to support the ladder rungs, and not fat enough to break.

What is claimed is:

1. A strain relief device for a test lead, comprising:
a housing that includes a generally elongate tubular member having a longitudinal cavity therein for retaining the test lead and maintaining a connection between the test lead and an electrical probe, the housing having a plurality of slots formed in sidewall portions thereof near an end of the tubular member to provide flexibility, thereby providing strain relief for the test lead.

2. The apparatus of claim 1 wherein the slots are arranged in linearly separated pairs.

3. The apparatus of claim 2 wherein adjacent pairs of the slots are angularly displaced from one another in the tubular member.

4. The apparatus of claim 3 wherein adjacent pairs of the slots are displaced 90° from one another.

5. The apparatus of claim 2 wherein the tubular member has a flared end where the slots are formed.

6. The apparatus of claim 5 wherein adjacent pairs of the slots are angularly displaced from one another in the tubular member.

7. The apparatus of claim 6 wherein adjacent pairs of the slots are displaced 90° from one another.

8. A method for providing strain relief for a test lead, comprising the steps of:
passing the test lead through a housing that includes a generally elongate tubular member having a longitudinal cavity therein for retaining the test lead and maintaining a connection between the test lead and an electrical probe; and
forming a plurality of slots in sidewall portions of the tubular member near an end thereof to provide flexibility, thereby providing strain relief for the test lead.

9. The method of claim 8 including the step of arranging the slots in linearly separated pairs.

10. The method of claim 9 including the step of arranging adjacent pairs of the slots to be angularly displaced from one another in the tubular member.

11. The method of claim 9 including the step of arranging adjacent pairs of the slots to be displaced 90° from one another.

12. The method of claim 9 including the step of arranging the tubular member to have a flared end where the slots are formed.

13. The method of claim 12 including the step of arranging adjacent pairs of the slots to be angularly displaced from one another in the tubular member.

14. The method of claim 13 including the step of arranging adjacent pairs of the slots to be displaced 90° from one another.
